(19) United States
(12) Patent Application Publication
(10) Pub. No.: US 2009/0017285 A1
(43) Pub. Date: Jan. 15, 2009

(54) POLYMER COMPOSITION FOR ENCAPSULATING A CHEMICAL AGENT COMPRISING AN OXIRANE COMPOSITION

(75) Inventor: Roger John Steadman, Leicestershire (GB)

Correspondence Address: PEPPER HAMILTON LLP, ONE MELLON CENTER, 50TH FLOOR, 500 GRANT STREET, PITTSBURGH, PA, 15219, US

(73) Assignee: Regency Chemical Company Limited

(21) Appl. No.: 10/595,828

(22) PCT Filed: Oct. 14, 2004
(86) PCT No.: PCT/GB04/04353

§ 371 Date: Jul. 31, 2008

(30) Foreign Application Priority Data
Nov. 18, 2003 (GB) 0326815.8

(51) Int. Cl. B32B 5/16; B32B 9/04; B05D 7/00; B32B 23/04; C08K 5/17; C09B 67/00

(52) U.S. Cl. 428/323; 428/704; 427/212; 428/532; 524/186; 8/552; 8/401

(57) ABSTRACT

The present invention relates to a polymer composition for encapsulating or carrying a chemical and/or biological agent, comprising either a polyamine or oxirane composition or mixture thereof. The present invention also relates to a substrate at least partially coated or wrapped with the composition and a method thereof, in addition to a method of dyeing fabrics using the composition.

The present invention relates to a composition for use in conjunction with chemical and biological agents.

A number of industries require compositions that enable chemical and biological agents to be easily applied to surfaces and to either allow the agents to adhere to the surface or permit the slow release of the agents contained therein. For example in the dye industry, dyes are used to colour substrates and tend to link with the substrate by absorption or by chemical linkage. For example, in the dyeing of fabrics it is a common problem for the dye to “rub” since many dyes link with the fabric by adsorption. Non-water soluble agents having certain pre-defined micron sizes (of approximately 5-50 microns) can be “encapsulated” to form suspensions in an aqueous medium, for example emulsion paint.

These “encapsulates” have little attraction for the substrate when applied through an aqueous media.

Encapsulates may also be used for the slow release of an agent such as a perfume or an insect repellent whereby it is desirable for the agent to be released over a prolonged period of time. Clearly, however, it is advantageous to extend the period of time over which the agent is released into the encapsulate's surrounding environment.

It would be advantageous to overcome or alleviate one or more of the problems associated with the prior art.

It is therefore an object of the present invention to provide a composition which acts as a carrier or wrap for a number of chemical or biological agents. Furthermore, it would be advantageous to provide a carrier or wrap composition which may be used to encapsulate a chemical or biological agent and which may be applied with the chemical or biological agent or prior to its application. The present invention may also provide a carrier or wrap composition which can be produced relatively easily and used for a number of applications and in a number of processes. A “carrier” or “wrap” composition should be taken to be defined as a substance which can wrap around an agent and may also be classed as a “carrier” as it can transport an encapsulate or an agent through a liquid medium and may also act as a substrate to which an agent or an encapsulate can be applied. Such a composition will usually be substantially inert with respect to the substrate wrapped or carried (i.e. they do not chemically interact with the agent, but may interact or react with a substrate (such as a garment or fibres of a fabric)).

In accordance with the present invention, there is provided a polymer composition for encapsulating or carrying a chemical and/or biological agent, comprising either a polyamine or oxirane composition or mixture thereof.

The composition may be cationic, and such a cationic polymer may comprise a cationic polyamide and a cationic heterocyclic compound and mixtures thereof. The polyamine polymer may also be a product of a polyamine and an oxirane composition. The oxirane composition may comprises (chloromethyl) oxirane, (bromoethyl) oxirane or a mixture thereof and optionally a cationic polymer. At least one polymer composition is preferably used to substantially encapsulate the chemical or biological agent, whilst a second polymer is preferably used to form a coating around the agent and first polymer mixture.

Preferably, the composition comprises (a) 1.6-hexane diamine N-(6-aminohexyl); (b) 1H-imidazole chloro methyl oxirane copolymer; and optionally (c) water. The 1.6-hexane diamine N-(6-aminohexyl) may or may not be in the presence of chloromethyl oxirane prior to production of the composition.

The composition provides a carrier or wrap composition which can be used for a wide range of applications and is relatively easy to produce and compatible with a wide range of industrial and non-industrial processes. The composition therefore provides for products which can be easily applied to substrates and removed after a period of time or left on the substrate so as to slowly release the product. It will be evident to the skilled addressee that 1.6-hexane diamine N-(6-aminohexyl) with chloromethyl oxirane is also known as Epichlorohydrin, bis hexamethylene-triamine polymer. Similarly, Chloro methyl oxirane is also epichlorohydrin which is also 1-chloro 3.2 epoxy propane. An application of the composition may be for dying fabric and it may be used to provide a “distressed” look on the fabric.

The composition will preferably comprise the ingredients in the following quantities: 25-45% 1.6-hexane diamine N-(6-aminohexyl) with chloromethyl oxirane, 5-25% 1H-imidazole chloro methyl oxirane copolymer in water and 40-60% water. More preferably, the composition will comprise the ingredients in the following quantities: 30-40% 1.6-hexane diamine N-(6-aminohexyl) with chloromethyl oxirane, 10-20% 1H-imidazole chloro methyl oxirane copolymer in water and 45-55% water. Most preferably, the composition will comprise the ingredients in the following quantities: 35% 1.6-hexane diamine N-(6-aminohexyl) with chloromethyl oxirane, 14.3% 1H-imidazole chloro methyl oxirane copolymer in water and 50.7% water.

The 1.6-hexane diamine N-(6-aminohexyl) with chloromethyl oxirane may contain the chloromethyl oxirane as a residual component. Alternatively, the chloromethyl oxirane may be present in an equal amount or as a major component with respect to 1.6-hexane diamine N-(6-aminohexyl). The exact concentration of the 1H-imidazole chloro methyl oxirane copolymer in the water solution may vary according to the application that the composition is to be used for.

Preferably, the concentration of the copolymer in water will be in the region of 30% to 50% in solution. More preferably, the concentration of the copolymer in water will be in the region of 35% to 45%.

It will be evident to the skilled addressee that the ingredients of the composition may contain impurities, which may or may not be important with regard to certain applications or processes that the composition is to be utilised for. Preferably, the ingredients contain less than 25% impurities. More preferably, the ingredients contain less than 15% impurities. Most preferably, the ingredients contain less than 5% impurities.

It will be evident to the skilled addressee that a “carrier” or “wrap” (two terms which can be used interchangably with one another) refers to a composition which is used as a support or vehicle to convey an agent and will commonly be a substantially inert or less inert substance than the agent itself. The carrier may be used to encapsulate the agent. The composition may encapsulate the chemical or biological agent and may additionally act as a film to which the agents (encapsulated or not) may be applied. Alternatively, the composition may also be used as a film that covers an agent or used to sandwich the agent between two layers of the composition. Ideally, the composition will be mixed with the agent prior to its use. The composition may also be applied at the same time as the agent. The agent may be an non-water soluble compound. The agent may also be in an aqueous form and/or dissolved or dispersed in a solvent Encapsulation may be achieved by mixing an agent with the composition at certain concentrations so as to promote encapsulation.

It will be apparent that a number of chemical/biological agents may be used in conjunction with the composition. A chemical and/or biological agent may be selected from, but is not limited to one of the following agents: dyes, perfumes, cosmetics, detergents, fragrances, pharmaceutical preparations, pheromones, insect repellents, anti-microbial agents, enzymes, micro-organisms. Potentially any non water soluble product in addition to those agents listed can be used in conjunction with the composition. Preferably, such an agent is relatively small in size, such as in the range of 50 microns. More preferably, the agent has a size in the range of 5-20 microns. Additional stabilising compounds may also be used in addition to the agent and composition mixture. Other additives may also be employed in addition to the agent and the composition to confer properties to the agent/composition and such compounds will be apparent to one skilled in the art. Examples of suitable additives are stabilizers and surfactants.

The agent may be a dye to dye fabrics and the like. The fabric (or similar material) may be a number of materials but will usually comprise a cellulose and/or protein based material. Such materials may be selected from cotton, silk or wool. In addition to the composition and the dye, other compounds may also be used to assist the action of the dye, such as salt, soda, wetting agents, leveling agents, dispersing agents. It will be evident to one skilled in the art that other compounds may also be used to assist the action of the dye and these will be apparent and applicable in a given application. Preferably, after the application of the dye, the fabric is treated with an after treatment. Such as after treatment may be by means of a cellulase enzyme, but could be any after treatment which produces a special effect such as a distressed look. The composition may be used to pre-treat the fabric prior to the application of the dye.

The pre-treatment of the fabric with the composition which coats the fabric with a polymer which enhances the affinity of a dye or colourant applied after the pre-treatment. Therefore, the dyes or colourants are attached to the composition rather than the fabric substrate which is contrary to existing techniques.

The composition and/or the agent may be applied to a surface by one or more of the following techniques: spraying, printing, padding and exhaustion techniques.

For the exhaustion technique, between 1-10% (but preferably 1-5%) of the composition is applied to the weight of the garment at pH 8-10 at 60° C. (±10° C.) for 10-30 minutes. The garment is then rinsed in cold water and dyed in a separate but using a dye at 60° C. (±10° C.) for 30 minutes. The garment is further washed and treated with a cellulose enzyme to produce a “distressed” effect.

For printing techniques, the composition is “thickened” by using a propriety thickener (such as carboxy methyl cellulose) and then printed onto the fabric to a given design. The fabric is then dried and dyed in an aqueous medium where the dyes will produce a much darker tone effect on the part of the fabric treated with the composition.

Padding techniques are similar to printing techniques, but the composition is applied at 20-40 gm/l in an aqueous solution. The fabric is then passed through the solution, squeezed, dried and made into garments which are then dyed and treated with a cellulose enzyme.

The composition and/or agent may be used on a large scale or small scale depending on the given application, for example, the dying of a large amount of jeans on a large scale production, or individual patterns being created on a garment on a small scale production.

In accordance with another aspect of the present invention, there is provided a method of coating or wrapping an encapsulated chemical or biological agent using a composition as described hereinabove comprising contacting the encapsulated agent with the composition.

Preferably, the coating or wrapping is carried out at temperatures between approximately 15-40° C. at a pH of between approximately 5.5-7.5 using a high speed stirrer. The average amount of the composition may equate to approximately 20% of the weight of the encapsulate.

In accordance with a further aspect of the present invention, there is provided a substrate at least partially coated or wrapped with a composition as described hereinabove.

The substrate may comprise a cellulose and/or protein based material, and/or an encapsulated chemical or biological agent.

The known use of colouring compositions, such as dyes, with cellulose and/or protein based substrates can lead to “running” owing to poor adhesive of the dye as described hereinabove. The composition of the present invention thus provides enhanced adherence of the dye as described hereinabove.

In one embodiment, where the substrate comprises an encapsulated chemical or biological agent, the present invention provides enhanced slow release of the encapsulated chemical or biological agent and can prolong the shelf-life of the encapsulated agent or a product containing such an agent by enhancing slow release ameliorating degradation caused by the exposure of the encapsulated agent to the environment. For example, degradation by oxidation or microbial degradation.

In accordance with an another aspect of the present invention, there is provided a process for dying garments using a composition as herein described above comprising:

(a) immersing the garment in water;

(b) heating the water to a temperature of between 15-30° C.;

(c) clean the garment so as to remove most contaminants;

(d) adjusting the pH of the liquid to between 8-10;

(e) adding the composition to the liquid;

(f) heating the liquid to a temperature of between 40-80° C.;

(g) draining the liquid and rinsing the garment;

(h) adjusting the pH of the liquid to between 5-8 if necessary;

(i) adding a colourant; and

(j) heating the liquid to approximately in the range of 50° C.-70° C.;

(k) optionally, after-treating the garment;

(l) draining the liquid from the garment

Preferably, the process will be performed in a drum dye machine which is capable of rotation. More preferably, the drum of the machine will be rotating substantially throughout the process in order to facilitate mixing of liquids and the garment. The colourants used may be a range of colourants which can be either natural or synthetic. Preferably, the colourant is chosen from one or more of the following colourants: reactive dyes, direct dyes, acid dyes and pigments.

Step (j) may be preceded with the additional step of adding a cellulase enzyme to the liquid.

The process may also provide for the addition of a suitable handle modifier if required. It will be apparent that such a handle modifier may be used to change the chamber of the fabric substrate to allow for after-treatments to be applied to the fabric for aesthetic purposes, such as certain effects etc. (is distressed looks etc.). The pH may be adjusted by using Soda or Salt where appropriate. It will also be apparent that a number of substances may be used which are basic or acidic in order to adjust the pH of a liquid.

The present invention will now be more particularly described with reference to the following Example.

### EXAMPLE 1

An experiment was conducted to assess the ability of a carrier composition to assist with the dying process of a garment.

A carrier composition was produced which had the following ingredients: 35 parts 1.6-hexane diamine N-(6-aminohexyl) with chloromethyl oxirane (CAS 68797-59-9, trade name Key 103), 14.3 parts 1H-imidazole chloro methyl oxirane copolymer in water (CAS 67953-56-4, trade name Product GBG) and 50.7 parts water.

A suitably clean and prepared garment was placed into a rotation drum dye machine (which is similar to a domestic tumble washer). Water was added to give a liquor in a ratio of 8:1 this is the ratio of the weight of garments to water, ie. for every kilo of garment, 8 kilos of water was added, 10:1 water to garment.

The temperature of the machine was adjust to 20-25° C. and the drum rotated in a continuous manner. Alkali was then added to machine to adjust the pH to 8.5-9.5. A solution based on 1-5% of the weight of the garment was added to the rotating drum (1% was used when a pale shade was being dyed, 5% was used when a darker shade was being dyed. A solution comprising 2.4% (based on the weight of the garment was subsequently added to the drum. The exact quantity of the composition added will be dictated by the shade of the dye (smaller amounts for pale colours and larger amounts for darker shades and colours).

The temperature within the drum was raised to 60° C. and the drum rotated for 15-25 minutes. The machine was then drained and then filled again and a rinse cycle commenced with a liquor ratio 10:1 for 5 minutes and repeated once, at the end of which liquor remained in the machine.

The pH was adjusted to be in the range of 6.0-7.5. Well dissolved colourants are then added into the drum. The colourants used can be a number of different colourants and can be selected from one or more of the following categories: Reactive dyes, Direct dyes, Acid dyes and Pigments.

The temperature of the drum was then raised to 60° C. and rotated for 20 minutes. Neutral cellulase in a quantity of 2-3% of the dry weight of garments was then added to the drum and the machine run for a further 45 minutes. The enzyme cellulase provides a differential distressed effect on the garment by differentially breaking the bond previously created between the polymer composition and the surface of the cellulose (provided that the garment is produced from a cellulose based material). The drum was then drained and the garments rinsed. Additionally, a suitable handle modifier could be added if required.

1. A polymer composition for encapsulating or carrying one or more chemical and/or biological agents, comprising a polyamine or oxirane composition or mixture thereof.

2. The composition of claim 1, wherein the polymer composition is cationic.

3. The composition of claim 1, wherein the oxirane is selected from (chloromethyl) oxirane, (bromoethyl) oxirane or mixtures thereof.

4. The composition of claim 1, wherein the composition comprises;
1,6-hexane diamine N-(6-aminohexyl);
1H-imidazole chloro methyl oxirane copolymer; and optionally
water.

5. (canceled)

6. The composition of claim 4, wherein the 1,6-hexane diamine N-(6-aminohexyl) comprises chloromethyl oxirane.

7. The composition of claim 1, comprising:
25-45% 1,6-hexane diamine N-(6-aminohexyl);
5-25% 1H-imidazole chloro methyl oxirane copolymer; and
40-60% water.

8. (canceled)

9. The composition of claim 4, wherein the 1H-imidazole chloro methyl oxirane copolymer is in a solution with water.

10. The composition of claim 9, wherein the 1H-imidazole chloro methyl oxirane copolymer is 30% to 5% of the solution.

11. The composition claim 1, wherein the polymer composition acts as is formed into a film to which the one or more chemical and/or biological agents are applied.

12. The composition of claim 11, wherein the one or more chemical and/or biological agents are non-water soluble.

13. The composition of claim 11, wherein the one or more chemical and/or biological agents are selected from one or more of: dyes, perfumes, cosmetics, detergents, fragrances, pharmaceutical preparations, pheromones, insect repellents, anti-microbial agents, enzymes and micro-organisms.

14. The composition claim 11, wherein the chemical and/or biological agent is up to 50 microns in size.

15. The composition of claim 11, further comprising one or more additives.

16. The composition of claim 11, wherein the one or more chemical and/or biological agents are dissolved or dispersed in a solvent.

17. A method for coating or wrapping a chemical or biological agent comprising contacting the chemical or biological agent with a composition of a polyamine, oxirane or mixture thereof.

18. The method of claim 17, wherein the method is carried out at temperatures in the range of 15-40° C. at a pH in the range of 5.5-7.5.

19. The method of claim 17 comprising combining the chemical or biological agent and the composition of a polyamine or oxirane or mixture thereof using a high speed stirrer.

20. A substrate comprising at least a partial coating of a composition of a polyamine, oxirane or mixture thereof.

21. The substrate of claim 20, wherein the substrate is a cellulose based material, protein based material or combinations thereof.

22. A method for dyeing fabric comprising contacting the fabric with a dye encapsulated in a composition of a polyamide, oxirane or mixture thereof.

23. The method of claim 22, wherein the encapsulated dye further comprises one or more additional compounds selected from salt, soda, wetting agents, leveling agents or dispersing agents.

24. (canceled)

25. The method of claim 22, further comprising treating the fabric with an after treatment after the step of contacting.

26. The method of claim 22, comprising pre-treating the fabric prior to applying the dye.

27. The method of claim 22, wherein the step of contacting is carried out by one or more technique selected from spraying, printing, padding or exhaustion techniques.

28. The method of claim 22, comprising the steps of:
immersing the fabric in water;
heating the water to a temperature of between 15-30° C.;
cleaning the fabric so as to remove most contaminants;
adjusting the pH of the liquid to between 8-10;
adding the composition to the water to form a liquid;
heating the liquid to a temperature of between 40-80° C.;
draining the liquid and rinsing the fabric;
adjusting the pH of the liquid to between 5-8 if necessary;
adding a colorant; and
heating the liquid to a temperature in the range of 50° C.-70° C.

29. The method of claim 28, wherein adding a cellulase enzyme to the liquid is performed after the step of adding a colorant.

30. The method of claim 28, wherein the colorant is selected from one or more colorant selected from reactive dyes, direct dyes, acid dyes and pigments.

31. The method of claim 28, further adding a handle modifier.
